(19) United States
(12) Patent Application Publication
(10) Pub. No.: US 2023/0269467 A1
(43) Pub. Date: Aug. 24, 2023

(54) ELECTRONIC APPARATUS AND CONTROL METHOD THEREOF, AND STORAGE MEDIUM

(71) Applicant: CANON KABUSHIKI KAISHA, Tokyo (JP)

(72) Inventors: Hidetaka UEMURA, Kanagawa (JP); Takayuki Sudo, Kanagawa (JP); Muneyoshi Maeda, Kanagawa (JP)

(21) Appl. No.: 18/169,969

(22) Filed: Feb. 16, 2023

(30) Foreign Application Priority Data
Feb. 24, 2022 (JP) 2022-027010

(51) Int. Cl. H04N 23/667; H04N 25/51; H04N 23/71; H04N 23/73; H04N 23/63; H04N 25/60

(52) U.S. Cl. CPC H04N 23/667; H04N 25/51; H04N 23/71; H04N 23/73; H04N 23/634; H04N 25/60

(57) ABSTRACT

An electronic apparatus comprises: an image sensor that shoots a subject and outputs image data; a controller that controls sensitivity of the image sensor; a display that displays an image based on the image data; and a selector that selects an acceptable noise level based on noise of the image displayed on the display. The controller limits the sensitivity based on the selected noise level.

### BACKGROUND OF THE INVENTION

### Field of the Invention

The present invention relates to an electronic apparatus, control method thereof, and storage medium, and more particularly to technology for addressing noise during gain amplification.

### Description of the Related Art

An image capturing apparatus conventionally has a function called Automatic Gain Control (AGC) limit. This function is aimed at preventing noise from increasing beyond a certain level, since the SN ratio deteriorates due to an increase in noise as a gain increases, which is a feature of gain control.

FIG. 15A to 15C are diagrams for explaining the relationship between ISO sensitivity and noise level with respect to gain in the image capturing apparatus.

FIG. 15A shows the relationship between ISO sensitivity and noise level in an image capturing apparatus that does not have an analog gain circuit, that is, an image capturing apparatus that performs gain control only with a digital gain circuit. As shown in FIG. 15A, as the gain increases, the noise level deteriorates.

Japanese Patent Laid-Open No. 2006-166341 discloses a method of limiting an amount of change in exposure at one time in order to suppress the occurrence of noise in image data and the occurrence of luminance flickering due to a large change in exposure.

On the other hand, among image capturing apparatuses each having a plurality of analog gain circuits, there are image capturing apparatuses that implement gain control to reduce the noise level as much as possible by selectively using a plurality of combination patterns of the analog gain circuits.

FIG. 15B shows the relationship between ISO sensitivity and noise level in an image capturing apparatus having a plurality of analog gain circuits. In this relationship, the noise level deteriorates as the digital gain increases, and at the analog gain switching point, the noise level improves, but from there, the noise level starts deteriorating again as the digital gain increases. In this example, the same analog gain is used up to ISO 1600, the next analog gain is used from ISO 1600 to ISO 3200, further different analog gains are used from ISO 3200 to ISO 6400, and ISO 6400 and higher.

Further, an image capturing apparatus that has a function of reducing noise accompanying an increase in gain by using an analog gain circuit having two reference sensitivities of low sensitivity and high sensitivity is generally known. FIG. 15C shows the relationship between gain and noise level in an image capturing apparatus in which an analog gain circuit uses two reference sensitivities for low sensitivity and high sensitivity. While different analog gain circuits are used for low sensitivity and high sensitivity, the gain from each of the reference sensitivities is increased only by using a digital gain.

The relationship between the gain and the noise level shown in FIG. 15C has a feature that the noise levels at the respective reference sensitivities are substantially the same, and that there is also a correlation between amounts of increase in noise when the gain is increased from the reference sensitivities. Taking advantage of this feature, in the editing process of video production, it is possible to reduce the labor by repeatedly using the same noise reduction (NR) setting for videos with the same noise level, that is, with the same amount of increase gain from the reference sensitivities.

If only a digital gain circuit is used as shown in FIG. 15A, more noise is generated than an analog gain circuit is used.

On the other hand, as shown in FIGS. 15B and 15C, if an analog gain circuit and a digital gain circuit are used together, there is a characteristic that an increase in noise level is not linear with respect to an increase in gain. Therefore, when the AGC limit function is used, there is a possibility that the gain is limited at a noise level lower than the noise level originally targeted to be limited. Further, in the image editing process, a problem arises in that it is not possible to know which gain settings will result in a similar noise level.

### SUMMARY OF THE INVENTION

The present invention has been made in consideration of the above situation, and realizes to limit the gain at a noise level that is originally targeted to be limited.

According to the present invention, provided is an electronic apparatus comprising: an image sensor that shoots a subject and outputs image data; a controller that controls sensitivity of the image sensor; a display that displays an image based on the image data; and a selector that selects an acceptable noise level based on noise of the image displayed on the display, wherein the controller limits the sensitivity based on the selected noise level, and wherein the controller and the selector are implemented by one or more processors, circuitry or a combination thereof.

Further, according to the present invention, provided is a control method of an electronic apparatus comprising: shooting a subject by an image sensor and outputting image data; displaying an image based on the image data on a display; selecting an acceptable noise level based on noise of the image displayed on the display; and limiting sensitivity of the image sensor based on the selected noise level.

Furthermore, according to the present invention, provided is a non-transitory computer-readable storage medium, the storage medium storing a program that is executable by the computer, wherein the program includes program code for causing the computer to execute a control method of an electronic apparatus, comprising: shooting a subject by an image sensor and outputting image data; displaying an image based on the image data on a display; selecting an acceptable noise level based on noise of the image displayed on the display; and limiting sensitivity of the image sensor based on the selected noise level.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a schematic configuration of an image capturing apparatus according to an embodiment of the invention;

FIG. 2 is a diagram for explaining the relationship between ISO sensitivity and noise level with respect to gain according to a first embodiment;

FIGS. 3A to 3F are diagrams illustrating examples of screens for selecting an acceptable noise level according to the first embodiment;

FIG. 4 is a flowchart illustrating processing according to the first embodiment;

FIG. 5 is a diagram for explaining the relationship between ISO sensitivity and noise level with respect to gain according to a second embodiment;

FIGS. 6A to 6F are diagrams illustrating examples of screens for selecting an acceptable noise level according to the second embodiment;

FIG. 7 is a flowchart illustrating processing according to the second embodiment;

FIG. 8 is a diagram illustrating an example of a screen for changing exposure settings in a noise level selection mode according to a third embodiment;

FIG. 9 is a flowchart of AE control according to camera modes according to the third embodiment;

FIGS. 10A and 10B are diagrams for explaining exposure adjustment at a set control resolution according to a fourth embodiment;

FIG. 11 is a flowchart of exposure adjustment processing at a set control resolution according to the fourth embodiment;

FIGS. 12A and 12B are diagrams illustrating an example of a screen for displaying a warning regarding a change in noise level and a screen for selecting whether or not to change the noise level according to a fifth embodiment;

FIG. 13 is a flowchart illustrating a procedure for displaying a warning and selecting whether or not to change the noise level according to the fifth embodiment;

FIGS. 14A to 14D are diagrams illustrating examples of warnings regarding a change in noise level according to the fifth embodiment; and

FIGS. 15A to 15C are diagrams illustrating relationships between ISO sensitivity and noise level with respect to gain in an image capturing apparatus.

### DESCRIPTION OF THE EMBODIMENTS

Hereinafter, embodiments will be described in detail with reference to the attached drawings. Note, the following embodiments are not intended to limit the scope of the claimed invention, and limitation is not made an invention that requires a combination of all features described in the embodiments. Two or more of the multiple features described in the embodiments may be combined as appropriate. Furthermore, the same reference numerals are given to the same or similar configurations, and redundant description thereof is omitted.

In this embodiment, a digital camera 100 will be described as an example of an image capturing apparatus.

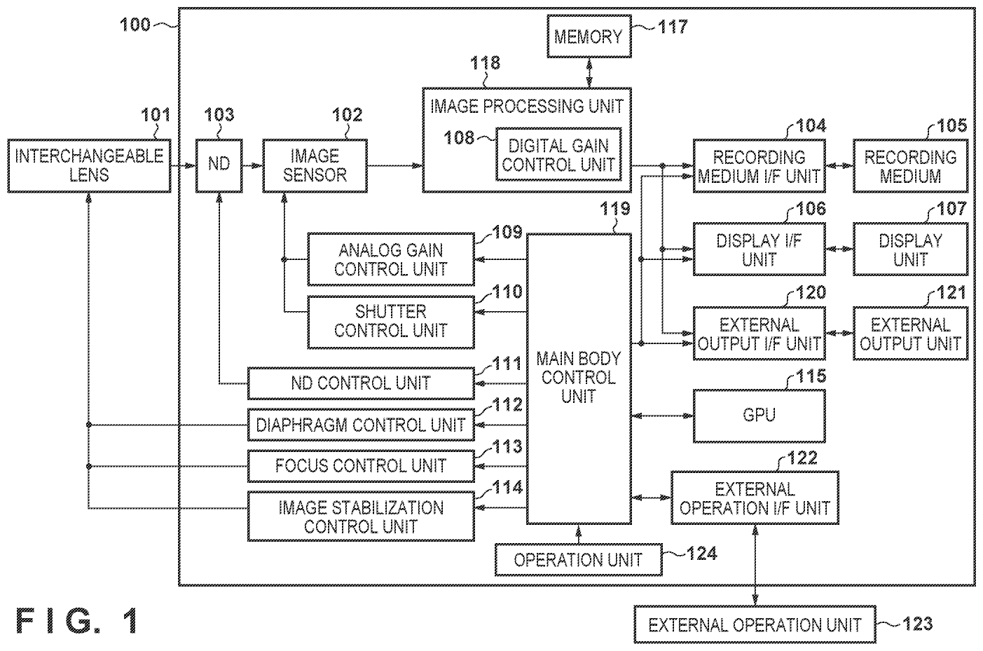

FIG. 1 is a block diagram illustrating a schematic configuration of a digital camera 100 according to this embodiment. The digital camera 100 holds inside many of the functional blocks shown in FIG. 1, and various operation units, a display unit 107 and an external output unit 121 are arranged on the surface of the digital camera 100.

An interchangeable lens 101 is an imaging lens composed of a plurality of lens groups and can be attached to and detached from the digital camera 100, and includes a focus lens, a zoom lens, a shift lens, and a diaphragm. Instead of the interchangeable lens 101 detachable from the digital camera 100, a lens integrated with the digital camera 100 may be used.

The neutral density (ND) filter 103 (variable light transmittance element) is provided in the digital camera to adjust the amount of incident light in addition to the diaphragm in the interchangeable lens 101.

An image sensor 102 has a pixel portion in which a plurality of pixels each having a photoelectric conversion element or elements are arranged two-dimensionally. The image sensor 102 photoelectrically converts an optical image of a subject formed by the interchangeable lens 101 at each pixel, performs gain control with an analog gain circuit, further performs analog-to-digital conversion with an analog-to-digital (A/D) conversion circuit, and outputs an image signal (RAW image data) pixel-by-pixel.

An image processing unit 118 performs image processing for correcting level differences originated from the image sensor 102 on the RAW image data sent from the image sensor 102. For example, when the pixel portion of the image sensor 102 has an optical black (OB) area that is shielded from light, the image signal of the pixels in the OB area is used to correct the level of the image signal of the pixels in an effective area that is not shielded from light, and the image signal of the defective pixel is corrected using image signals of surrounding pixels. In addition, the image processing unit 118 performs processing such as correction for decrease in marginal illumination, color correction, edge enhancement, noise reduction, gamma correction, demosaicing, and compression, and performs digital gain processing using a digital gain control unit 108.

After the image processing unit 118 performs the above processing on the RAW image data input from the image sensor 102, the image processing unit 118 outputs the corrected image data to each unit. A memory 117 temporarily stores image data.

A main body control unit 119 includes a CPU, a ROM, a RAM, and so on. The CPU develops a program stored in the ROM in the work area of the RAM and executes it, thereby controlling the overall operation of the digital camera 100. Further, the main body control unit 119 implements each process of this embodiment, which will be described later, by executing a program stored in the ROM. The RAM is used to develop constants and variables for operation of the main body control unit 119, programs read from the ROM, and the like.

A recording medium interface (I/F) unit 104 is an interface between a recording medium 105 and the digital camera 100, and controls recording of image data input from the image processing unit 118 to the recording medium 105 and reading of recorded image data from the recording medium 105. The recording medium 105 is a recording medium composed of a semiconductor memory or the like for recording captured videos or image data, and the recording medium 105 executes recording of image data and reading of the recorded image data according to control by the recording medium I/F unit 104.

A display I/F unit 106 performs superimposing and resizing of the video data from the image processing unit 118 and image data such as character strings and graphics rendered in a video RAM (VRAM) by a graphics processing unit (GPU) 115, and outputs the data to the display unit 107. The display unit 107 is a monitor or viewfinder that displays image data output from the display I/F unit 106 for angle-of-view confirmation.

The GPU 115 is a rendering engine that renders various information displays and menu screens of the digital camera 100 in the VRAM. In addition to rendering functions of rendering character strings, graphics, and so forth, the GPU 115 has rendering functions for scaling, rotating, and layer composition. Image data such as character strings and graphics rendered in the VRAM has an alpha channel representing transparency, and can be displayed on-screen on the video by the display I/F unit 106.

The digital gain control unit 108, an analog gain control unit 109, a shutter control unit 110, an ND control unit 111, and a diaphragm control unit 112, which will be described below, are all control units for exposure control. The main body control unit 119 controls these control units based on the brightness level of the image data output from the image processing unit 118 calculated by the main body control unit 119 or based on the operating parameters manually set by a photographer. The digital gain control unit 108 controls the gain of the image processing unit 118, and the analog gain control unit 109 controls the gain of the image sensor 102. The shutter control unit 110 controls the shutter speed of the image sensor 102. The ND control unit 111 controls the amount of light to be incident on the image sensor 102 via the ND filter 103. The diaphragm control unit 112 controls the diaphragm of the interchangeable lens 101.

A focus control unit 113 performs different operations depending on whether the focus actuation state held by the main body control unit 119 indicates autofocus (AF) or manual focus (MF). In a case of MF, the focus control unit 113 stops control. In this case, the photographer can adjust the focus arbitrarily by rotating a focus ring 134 incorporated in the interchangeable lens 101. During AF, the main body control unit 119 refers to the image data output from the image processing unit 118 to calculate focus state information, and based on the focus state information, the focus control unit 113 controls the focus lens in the interchangeable lens 101. The main body control unit 119 may set an AF frame in a partial area of the image data and the focus state information may be calculated based only on the subject within the AF frame.

An image stabilization control unit 114 performs optical image stabilization processing by controlling the shift lens within the interchangeable lens 101 so as to cancel image blur.

An external output I/F unit 120 performs resizing processing on the video data from the image processing unit 118. Further, it performs signal conversion suitable for the standard of the external output unit 121 and adds a control signal, and outputs the results to the external output unit 121. The external output unit 121 is a terminal for outputting video data to the outside, such as an SDI terminal or HDMI (registered trademark) terminal. For example, a monitor display or an external recording device may be connected.

An external operation I/F unit 122 is an interface that receives control instructions from an external operation unit 123 and notifies the main body control unit 119 of them. For example, it is an infrared remote control receiver, a wireless LAN interface, an LANC (registered trademark). The external operation unit 123 transmits control instructions to the external operation I/F unit 122. The external operation unit 123 can send instructions corresponding to various operations that can be performed by the digital camera 100 and interchangeable lens 101. In addition, it can also send setting change information on the menu screen displayed on the display unit 107.

An operation unit 124 includes members such as keys (buttons), dials, tactile switches, and rings. These members have functions of receiving the operation of a photographer and notifying the main body control unit 119 of control instructions. Among these operation units, the functions of the keys may be exchanged or reassigned to other functions by setting from the menu screen.

### First Embodiment

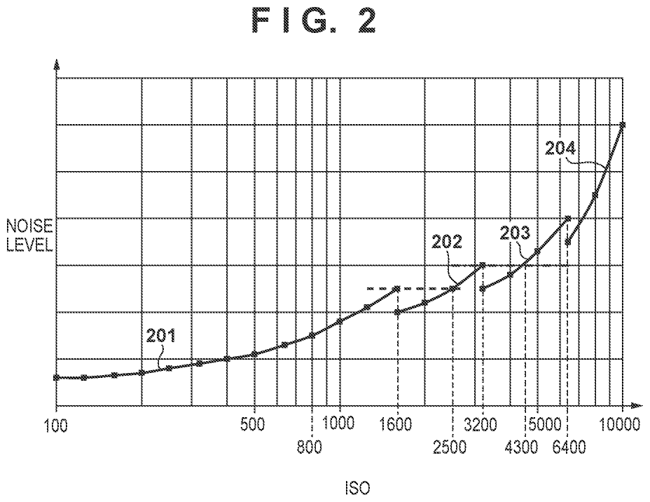

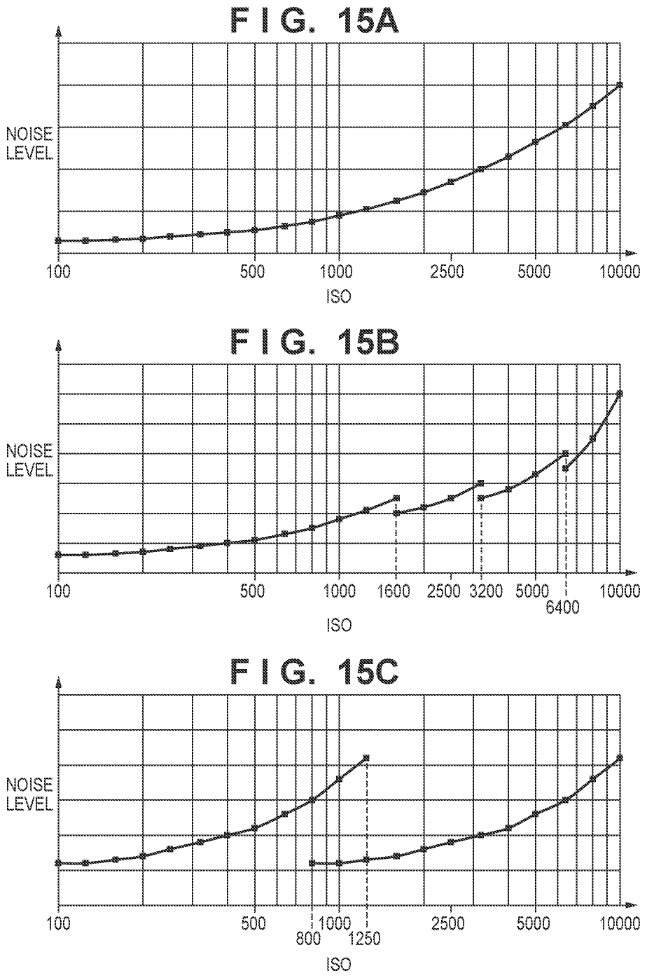

In the first embodiment, a case where an analog gain control in the image sensor 102 and the digital gain control unit 108 are used to control the ISO sensitivity shown in FIG. 15B will be explained. In addition, in order to explain the first embodiment in an easy-to-understand manner, the explanation will be made with reference to FIG. 2 here. In FIG. 2, a graph 201 corresponding to ISO 100 to ISO 1600 shows the relationship between ISO sensitivity and noise level when a first analog gain and digital gain are used, and a graph 202 corresponding to ISO 1600 to ISO 3200 shows the relationship between ISO sensitivity and noise level when a second analog gain and digital gain are used. A graph 203 corresponding to ISO 3200 to ISO 6400 shows the relationship between ISO sensitivity and noise level when a third analog gain and digital gain are used, and a graph 204 corresponding to ISO 6400 and above shows the relationship between ISO sensitivity and noise level when a fourth analog gain and digital gain are used. The relationship between ISO sensitivity (gain) and noise level may be obtained in advance and stored in the ROM of the main body control unit 119, or may be stored in a memory (not shown). As can be seen from FIG. 2, in this case, the increase in noise level with increasing gain is not linear.

Therefore, in the first embodiment, the gain is limited by the noise level instead of the conventional AGC limit.

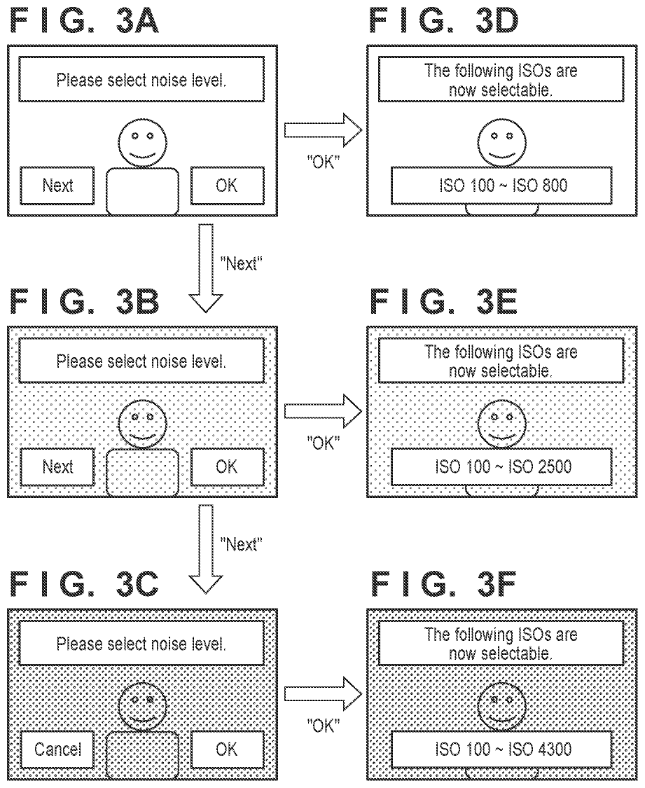

FIGS. 3A to 3C show example screens for a user to select an acceptable noise level. When the user selects “Next” on the screen shown in FIG. 3A, the screen transitions to the screen shown in FIG. 3B with an increased noise level, and when the user further selects “Next”, the screen transitions to the screen shown in FIG. 3C with a further increased noise level. If the user selects “Cancel” on the screen shown in FIG. 3C, the user can exit from the selection screen.

Further, when the user confirms the noise state of the image shown in FIG. 3A and selects “OK”, the screen transitions to the screen shown in FIG. 3D, the selectable range of ISO sensitivity is determined, and the determined range of selectable ISO sensitivity is displayed and notified to the user. For example, if the image shown in FIG. 3A is obtained by applying a gain corresponding to ISO 800 using the first analog gain, a message “The following ISOs are now selectable” and a selectable range of “ISO 100 to ISO 800” are displayed.

Similarly, when the user confirms the noise state of the image shown in FIG. 3B and selects “OK”, the screen transitions to the screen shown in FIG. 3E, the selectable range of ISO sensitivity is determined, and the determined range of selectable ISO sensitivity is displayed and notified to the user. In the example shown in FIG. 2, the noise levels are similar in a case where a gain corresponding to ISO 1600 is applied using the first analog gain and in a case where a gain corresponding to ISO 2500 is applied using the second analog gain. Therefore, for example, if an image obtained by applying a gain corresponding to ISO 2500 using the second analog gain is shown in FIG. 3B, in FIG. 3E, a message “The following ISOs are now selectable” and a selectable range of “ISO 100 to ISO 2500” are displayed. Note that the image shown in FIG. 3B may be an image obtained by applying a gain corresponding to ISO 1600 using the first analog gain.

Further, when the user confirms the noise state of the image shown in FIG. 3C and selects “OK”, the screen transitions to the screen shown in FIG. 3F, the selectable range of ISO sensitivity is determined, and the determined range of selectable ISO sensitivity is displayed and notified to the user. In the example shown in FIG. 2, the noise levels are similar in a case where a gain corresponding to ISO 3200 is applied using the second analog gain and a case where a gain corresponding to ISO 4300 is applied using the third analog gain. Therefore, for example, if an image obtained by applying a gain corresponding to ISO 4300 using the third analog gain is shown in FIG. 3C, in FIG. 3F, a message “The following ISOs are now selectable” and a selectable range of “ISO 100 to ISO 4300” are displayed. Note that the image shown in FIG. 3C may be an image obtained by applying a gain corresponding to ISO 3200 using the second analog gain.

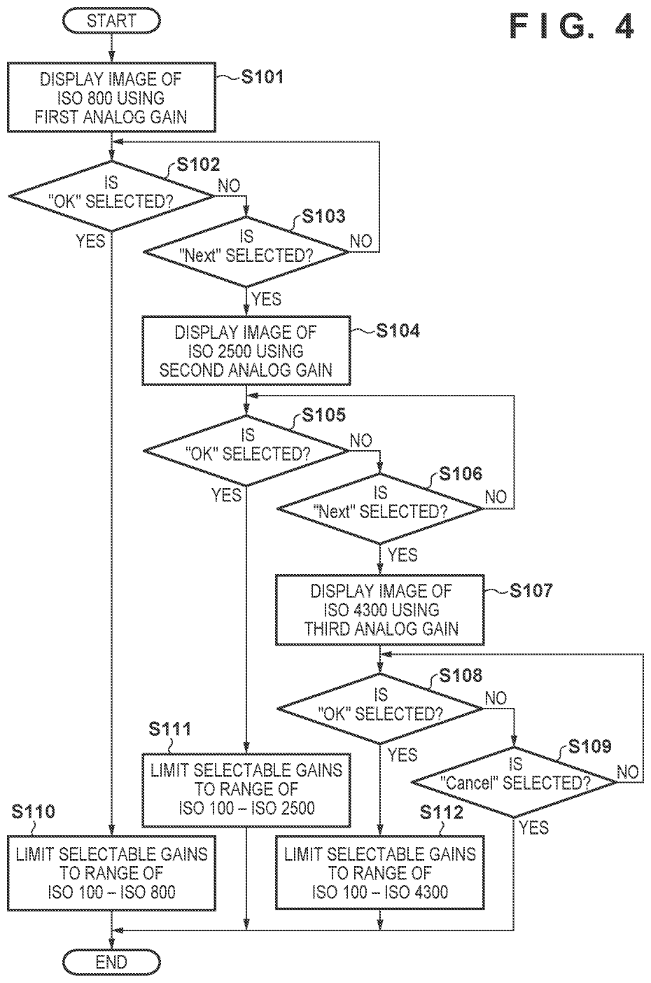

FIG. 4 is a flowchart showing processing for selecting an acceptable noise level and limiting gain according to the screen transitions shown in FIGS. 3A to 3F, according to the first embodiment.

First, in step S101, an image obtained by applying a gain corresponding to ISO 800 using the first analog gain is displayed on a noise selection screen (the screen shown in FIG. 3A), and the process proceeds to step S102. If “OK” is selected in step S102, the process proceeds to step S110, and after limiting the selectable gains to the range of ISO 100 to ISO 800, the processing ends. At this time, the screen shown in FIG. 3D is displayed.

On the other hand, if “OK” is not selected in step S102, the process proceeds to step S103 to determine whether or not “Next” is selected. If “Next” is selected, the process proceeds to step S104, an image obtained by applying a gain corresponding to ISO 2500 using the second analog gain is displayed on the noise selection screen (the screen shown in FIG. 3B), and the process proceeds to step S105. Note that if “Next” is not selected in step S103, the process returns to step S102.

If “OK” is selected in step S105, the process proceeds to step S111, and after limiting the selectable gains to the range of ISO 100 to ISO 2500, the processing ends. At this time, the screen shown in FIG. 3E is displayed.

If “OK” is not selected in step S105, the process proceeds to step S106 to determine whether or not “Next” is selected. If “Next” is selected, the process proceeds to step S107, an image obtained by applying a gain corresponding to ISO 4300 using the third analog gain is displayed on the noise selection screen (the screen shown in FIG. 3C), and the process proceeds to step S108. If “Next” is not selected in step S106, the process returns to step S105.

If “OK” is selected in step S108, the process proceeds to step S112, and after limiting the selectable gains to the range of ISO 100 to ISO 4300, the acceptable noise level selection processing is ended. At this time, the screen shown in FIG. 3F is displayed. If “OK” is not selected in step S108, the process advances to step S109 to determine whether “Cancel” is selected. If “Cancel” is selected, the processing is terminated, and if “Cancel” is not selected, the process returns to step S108.

As described above, according to the first embodiment, it is possible to limit the ISO sensitivity so that the noise level is equal to or less than the noise level permitted by the user. As a result, it is possible to solve the problem that if the AGC limit function is used, the gain is limited at a noise level lower than the noise level originally targeted to be limited.

Note that the above processing is effective for gain control as shown in FIG. 15B, so in the case of controlling gain only with digital gain as shown in FIG. 15A, a conventional AGC limit function may be used.

In the above example, a case where three different acceptable noise levels are provided is explained, however, the present invention is not limited to this, and acceptable noise levels other than three different acceptable noise levels, for example, two or four different acceptable noise levels, from which an acceptable noise level is selected, may be provided depending on the feature of each analog gain circuit and each digital gain circuit.

Furthermore, in the examples shown in FIGS. 3A to 3F and FIG. 4, the case where images are displayed in order from the lowest noise level has been described, but it may be controlled so that the images are displayed in order from the highest noise level.

Alternatively, images with different noise levels (for example, the images shown in FIGS. 3A to 3C) may be displayed side by side on one screen, and the user may select an image with an acceptable noise level.

### Second Embodiment

Next, a second embodiment of the present invention will be described.

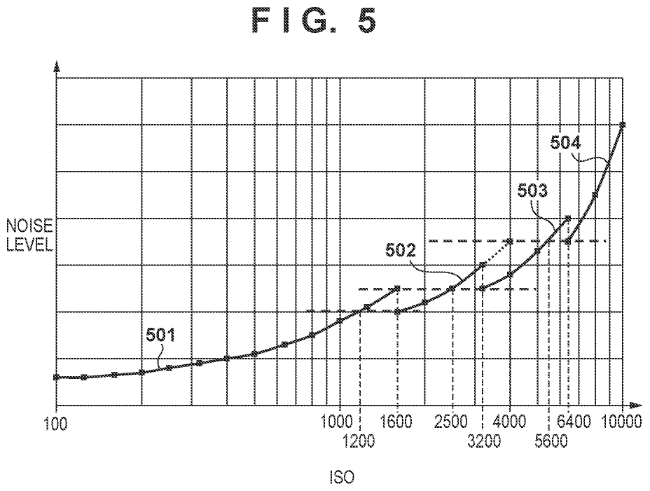

If the gain control described in the first embodiment is performed, there is a feature that there are a plurality of gain values that enables shooting with the similar noise level. Using this feature, in the second embodiment, control for presenting options of digital gain that enables shooting at a similar noise level will be described. Also in the second embodiment, a case where an analog gain control in the image sensor 102 and the digital gain control unit 108 are used to perform the gain control shown in FIG. 15B will be explained. In addition, in order to explain the second embodiment in an easy-to-understand manner, the explanation will be made with reference to FIG. 5 here. In FIG. 5, a graph 501 corresponding to ISO 100 to ISO 1600 shows the relationship between gain and noise level when the first analog gain and digital gain are used, and a graph 502 corresponding to ISO 1600 to ISO 3200 (or ISO 4000) shows the relationship between gain and noise level when the second analog gain and digital gain are used. A graph 503 corresponding to ISO 3200 to ISO 6400 shows the relationship between gain and noise level when the third analog gain and digital gain are used, and a graph 504 corresponding to ISO 6400 and above shows the relationship between gain and noise level when the fourth analog gain and digital gain are used. As can be seen from FIG. 5, in this case, the increase in noise level with increasing gain is not linear.

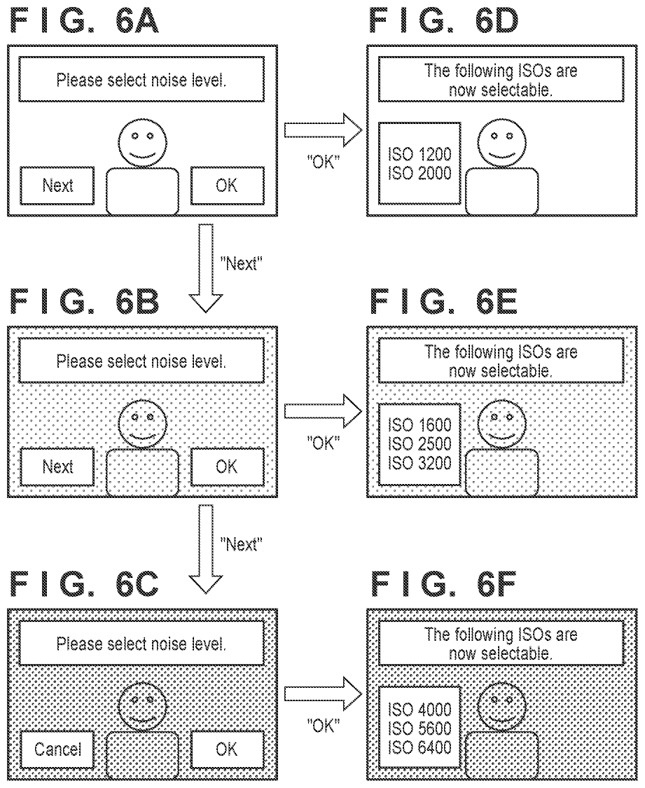

FIGS. 6A to 6C show example screens for presenting the user with options for digital gains that can be shot at similar noise levels. When the user selects “Next” on the screen shown in FIG. 6A, the screen transitions to the screen shown in FIG. 6B with an increased noise level, and when the user further selects “Next”, the screen transitions to the screen shown in FIG. 6C with a further increased noise level. If the user selects “Cancel” on the screen shown in FIG. 6C, the user can exit from the selection screen.

Further, when the user confirms the noise state of the image shown in FIG. 6A and selects “OK”, the screen transitions to the screen shown in FIG. 6D, the selectable ISO sensitivities are determined, and choices of the determined selectable ISO sensitivities are displayed and notified to the user. In the example shown in FIG. 5, the noise levels are similar in a case where a gain corresponding to ISO 1200 is applied using the first analog gain and in a case where a gain corresponding to ISO 1600 is applied using the second analog gain. Therefore, if the image shown in FIG. 6A is obtained by applying a gain corresponding to ISO 1600 using the second analog gain, for example, a message “The following ISOs are now selectable” and selectable ISOs of “ISO 1200, ISO 1600” are displayed. Note that the image shown in FIG. 6A may be an image obtained by applying a gain corresponding to ISO 1200 using the first analog gain.

Similarly, when the user confirms the noise state of the image shown in FIG. 6B and selects “OK”, the screen transitions to the screen shown in FIG. 6E, the selectable ISO sensitivities are determined, and choices of the determined selectable ISO sensitivities are displayed and notified to the user. In the example shown in FIG. 5, the noise levels are similar in a case where a gain corresponding to ISO 1600 is applied using the first analog gain, in a case where a gain corresponding to ISO 2500 is applied using the second analog gain, and in a case where a gain corresponding to ISO 3200 is applied using the third analog gain. Therefore, for example, if the image shown in FIG. 6B is obtained by applying a gain corresponding to ISO 3200 using the third analog gain, a message “The following ISOs are now selectable” and selectable ISOs of “ISO 1600, ISO 2500, ISO 3200” are displayed. Note that the image displayed in FIG. 6B may be an image obtained by applying a gain corresponding to ISO 1600 using the first analog gain or an image obtained by applying a gain corresponding to ISO 2500 using the second analog gain.

Further, when the user confirms the noise state of the image shown in FIG. 6C and selects “OK”, the screen transitions to the screen shown in FIG. 6F, the selectable ISO sensitivities are determined, and choices of the determined selectable ISO sensitivities are displayed and notified to the user. In the example shown in FIG. 5, the noise levels are similar in a case where a gain corresponding to ISO 4000 is applied using the second analog gain, in a case where a gain corresponding to ISO 5600 is applied using the third analog gain, and in a case where a gain corresponding to ISO 6400 is applied using the fourth analog gain. Therefore, for example, if the image shown in FIG. 6C is obtained by applying a gain corresponding to ISO 6400 using the fourth analog gain, a message “The following ISOs are now selectable” and selectable ISOs of “ISO 4000, ISO 5600, ISO 6400” are displayed. Note that the image shown in FIG. 6C may be an image obtained by applying a gain corresponding to ISO 4000 using the second analog gain or an image obtained by applying a gain corresponding to ISO 5600 using the third analog gain.

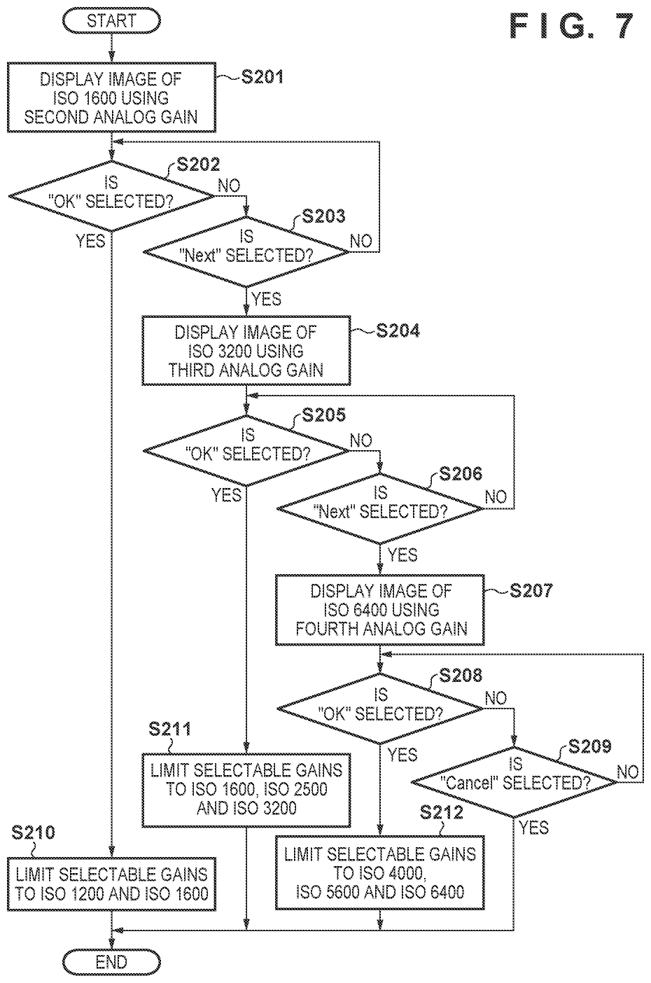

FIG. 7 is a flowchart showing processing for limiting gain by selecting a noise level according to the screen transitions shown in FIGS. 6A to 6F, according to the second embodiment.

First, in step S201, an image obtained by applying a gain corresponding to ISO 1600 using the second analog gain is displayed on a noise selection screen (the screen shown in FIG. 6A), and the process proceeds to step S202. If “OK” is selected in step S202, the process proceeds to step S210, and after limiting the selectable gains to ISO 1200 and ISO 1600, the processing ends. At this time, the screen shown in FIG. 6D is displayed.

On the other hand, if “OK” is not selected in step S202, the process proceeds to step S203 to determine whether or not “Next” is selected. If “Next” is selected, the process proceeds to step S204, an image obtained by applying a gain corresponding to ISO 3200 using the third analog gain is displayed on the noise selection screen (the screen shown in FIG. 6B), and the process proceeds to step S205. Note that if “Next” is not selected in step S203, the process returns to step S202.

If “OK” is selected in step S205, the process proceeds to step S211, and after limiting the selectable gains to ISO 1600, ISO 2500 and ISO 3200, the processing ends. At this time, the screen shown in FIG. 6E is displayed.

If “OK” is not selected in step S205, the process proceeds to step S206 to determine whether or not “Next” is selected. If “Next” is selected, the process proceeds to step S207, an image obtained by applying a gain corresponding to ISO 6400 using the fourth analog gain is displayed on the noise selection screen (the screen shown in FIG. 6C), and the process proceeds to step S208. If “Next” is not selected in step S206, the process returns to step S205.

If “OK” is selected in step S208, the process proceeds to step S212, and after limiting the selectable gain to ISO 4000, ISO 5600 and ISO 6400, the acceptable noise level selection processing is ended. At this time, the screen shown in FIG. 6F is displayed. If “OK” is not selected in step S208, the process advances to step S209 to determine whether “Cancel” is selected. If “Cancel” is selected, the processing is terminated, and if “Cancel” is not selected, the process returns to step S208.

As described above, according to the second embodiment, it is possible to make only gain values whose noise levels accepted by the user are similar be selectable. As a result, it is possible to present to the user, in an easy-to-understand manner, shooting conditions with which the same NR setting can be used in the editing process.

Note that the above processing is effective for gain control as shown in FIG. 15B, so in the case of controlling gains only with digital gain as shown in FIG. 15A, the above processing may be disabled so as not be operated.

In the above example, a case where three different acceptable noise levels are provided is explained, however, the present invention is not limited to this and, acceptable noise levels other than three different acceptable noise levels, for example, two or four different acceptable noise levels, from which an acceptable noise level is selected, may be provided depending on the feature of each analog gain circuit and each digital gain circuit.

Furthermore, in the examples shown in FIGS. 6A to 6F and 7, the case where the images are displayed in order from the lowest noise level has been described, but the control may be performed so that the images are displayed in order from the highest noise level.

Alternatively, images with different noise levels (for example, the images shown in FIGS. 6A to 6C) may be displayed side by side on one screen, and the user may select an image with an acceptable noise level.

### Third Embodiment

Next, a third embodiment of the present invention will be described.

In the third embodiment, the screens shown in FIGS. 6A to 6C are used to automatically control the brightness of the image to a target value when the user selects the noise level, that is, to perform so-called AE control. In this embodiment, a camera mode for displaying the noise level selection screen is called “noise level selection mode”, and the other modes are called “normal mode”. Mode change control and exposure change control including AE are instructed by the main body control unit 119. In the noise level selection mode, the gain value is changed according to the noise level selected by the user, and AE control is performed using exposure control variables other than gain. On the other hand, in the normal mode in which noise level selection is not performed, AE control is performed using exposure variables including gain.

In this embodiment, an example of the ND filter 103 shown in FIG. 1 is a known transmittance variable ND filter whose transmittance varies depending on the voltage value, and its transmittance is controlled by the ND control unit 111.

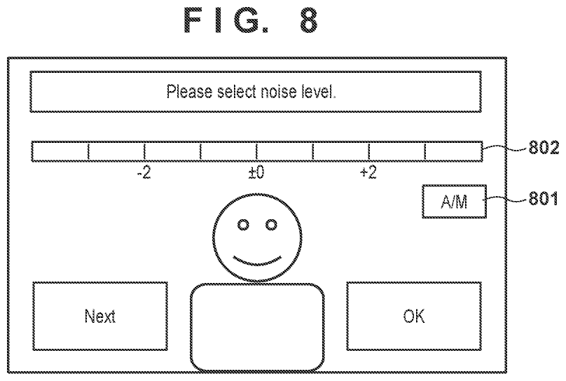

FIG. 8 is a diagram showing an example of a screen for changing exposure settings in the noise level selection mode.

A button 801 is a button for switching between an AE mode that automatically adjusts the exposure and a manual mode that allows the user to manually adjust the exposure by individually adjusting the diaphragm, ND filter, shutter, and the like. Each time the button 801 is pressed, the AE mode and the manual mode are switched. By selecting the manual mode even in the noise level selection mode, the user can select arbitrary exposure settings. A description of the processing in the manual mode is omitted.

An AE shift bar 802 is a setting bar used by the user to change the target brightness of a video in the AE mode. This function is commonly known as the AE shift function, and the AE shift bar 802 is also displayed in the normal mode. The luminance value of the target brightness in the AE mode is changed according to the user's instruction on the AE shift bar 802, and when the central position ±0 is selected, it becomes a value recommended by the camera. Moving toward the +2 side changes the target brightness to a brighter target brightness with respect to the recommended value, and moving toward the −2 side changes the target brightness to a darker target brightness. The amount of change in brightness increases as the distance from ±0 located at the center increases.

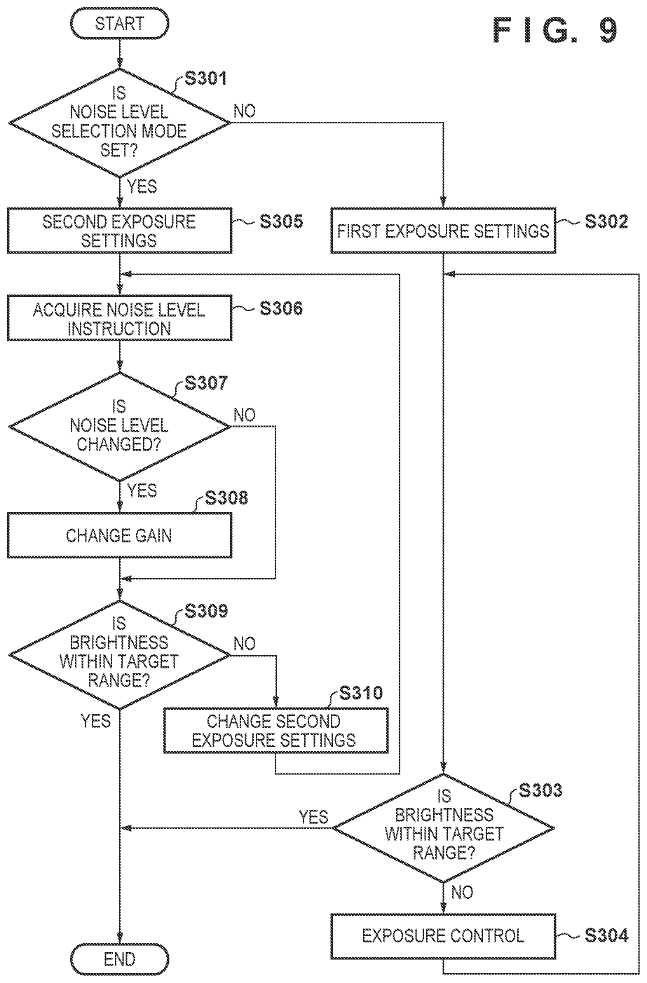

Next, control in the AE mode will be described with reference to FIG. 9. FIG. 9 is a flowchart of AE control according to camera modes.

In step S301, it is determined whether or not the noise level selection mode is set. If the normal mode is set, the process proceeds to step S302. In step S302, the main body control unit 119 changes to first exposure settings, which is the AE control settings for the normal mode. In known AE control, exposure control is performed so that the average value of luminance of pixels within a preset photometry evaluation frame within a predetermined threshold becomes a target luminance value. Accordingly, the first exposure settings include the following settings and the like. That is, the settings include the position and size of a photometry evaluation frame within which the brightness of the image is to be evaluated, a threshold value for color or luminance information for performing photometry by removing saturated portion and dark portion that includes a lot of noise, and a luminance range to be a target brightness. Further, the settings also include an exposure control change amount related to exposure responsiveness when adjusting the brightness to the target value, for example, an exposure change amount per frame, which affects the time required to reach the target brightness.

After changing to the first exposure settings, the process advances to step S303 to determine whether the brightness is within the target luminance range. If the brightness is not within the target luminance range, the process proceeds to step S304, and the exposure control values of the diaphragm, shutter, gain, and variable ND are changed according to the target luminance and the exposure control change amount. After changing the exposure control values, the process returns to step S303, and the exposure control values are changed until the brightness falls within the target luminance range. On the other hand, if it is determined in step S303 that the brightness is within the target luminance range, the process ends.

If it is determined in step S301 that the noise level selection mode is set, the process proceeds to step S305 to change to second exposure settings, which is the AE control settings suitable for the noise level selection mode. In the noise level selection mode, it is assumed that the user may want to check mainly random noise in the dark portion. Therefore, in the second exposure settings, an AE setting is made such that confirmation of dark portion is prioritized comparing to the first exposure settings. In the present embodiment, a case is taken as an example in which the luminance value of target brightness is set lower than that in the normal mode. As a result, if ±0 is selected in the AE shift bar 802 in both of the normal mode and the noise level selection mode, even for the same subject, the image in the noise level selection mode becomes darker than in the normal mode. Note that the photometry evaluation frame may be set in the dark portion in the normal mode. In addition, the threshold value of luminance information to be evaluated may be increased, and in this case, the image becomes darker because the evaluative photometry is performed including an object that is brighter than in the normal mode.

Also, in the normal mode, a rapid change of brightness in a video may pose a problem. On the other hand, in the noise level selection mode, the responsiveness to change of brightness is less likely to be an issue. Therefore, in the noise level selection mode, the exposure control change amount related to responsiveness may be set to a value larger than that in the normal mode.

After changing to the second exposure settings, the process proceeds to step S306 to obtain the noise level selected by the user. Subsequently, the process proceeds to step S307 to determine whether the selected noise level has been changed. If it is determined that the selected noise level has been changed, the process advances to step S308 to change the gain to that corresponding to the noise level selected by the user, as in the first embodiment.

After changing the gain, or if it is determined in step S307 that the selected noise level is not changed, the process advances to step S309 to determine whether the brightness is within the target range in the same manner as in step S303, and if no, the process proceeds to step S310. In step S310, the exposure control values of the diaphragm, shutter, and variable ND are changed according to the target luminance value and the exposure control change amount included in the second exposure settings. The gain is not changed here. Further, if the aperture value is changed, correction for the decreased marginal illumination that changes according to the aperture may be changed, which may cause change in the confirmed noise characteristics. Also, it is generally known that changing the transmittance of the variable ND exerts little influence on the image quality. Therefore, in changing the second exposure settings, which is AE control at the time of noise level selection, AE control that gives priority to changing the transmittance of the variable ND is performed.

After changing the exposure, the process returns to step S306, where the gain is changed according to the noise level and AE control is performed using values other than the gain. If it is determined in step S309 that the brightness is within the target range, the processing ends.

As described above, according to the third embodiment, in the noise level selection mode, AE control can be performed while maintaining the selected noise level. In addition, it is possible to implement AE control that emphasizes a dark portion, which is suitable for the noise level selection mode. As a result, when the user selects the noise level, it is possible to easily issue an instruction to change the noise level while confirming the dark random noise in the dark portion. Although the above processing is mainly aimed at confirming dark random noise, there are cases where it is desired to confirm noise that occurs in portions other than a dark portion, such as optical shot noise. Therefore, the AE shift bar 802 allows the user to specify the target brightness value to be used in AE control.

### Fourth Embodiment

Next, a fourth embodiment of the present invention will be described.

When the gain control as shown in FIG. 15B is performed, there is a characteristic that there may be a plurality of gain values that enable shooting with a similar noise level. As can be seen from the intersections of the dotted lines in FIG. 5 representing the noise level shown in FIG. 6B and the graphs 501, 502, and 503, the ISO values that can be set are not evenly spaced. That is, the ISO value cannot be changed with control resolution of the ISO value set in the digital camera 100. Therefore, in the fourth embodiment, the control to change the ISO value that matches the set control resolution will be described.

When the ISO value is controlled by the control resolution, such as ⅓ or ⅔ steps, set by the digital camera 100 at a similar noise level, it is necessary to change only the exposure value while maintaining a similar noise level. Therefore, it is necessary to adjust the control resolution using exposure control values that exert little influence on the noise level. In addition, it is necessary to use exposure control values that exert little influence on image formation of captured images. For example, it is better not to perform exposure adjustment by the diaphragm control unit 112 and the shutter control unit 110, which affect the depth of field and dynamic resolution. Therefore, exposure adjustment control that changes the exposure value by preferably using the ND filter 103 and the image sensor 102 which has an analog gain circuit capable of realizing a similar noise level with little variation in noise level is performed.

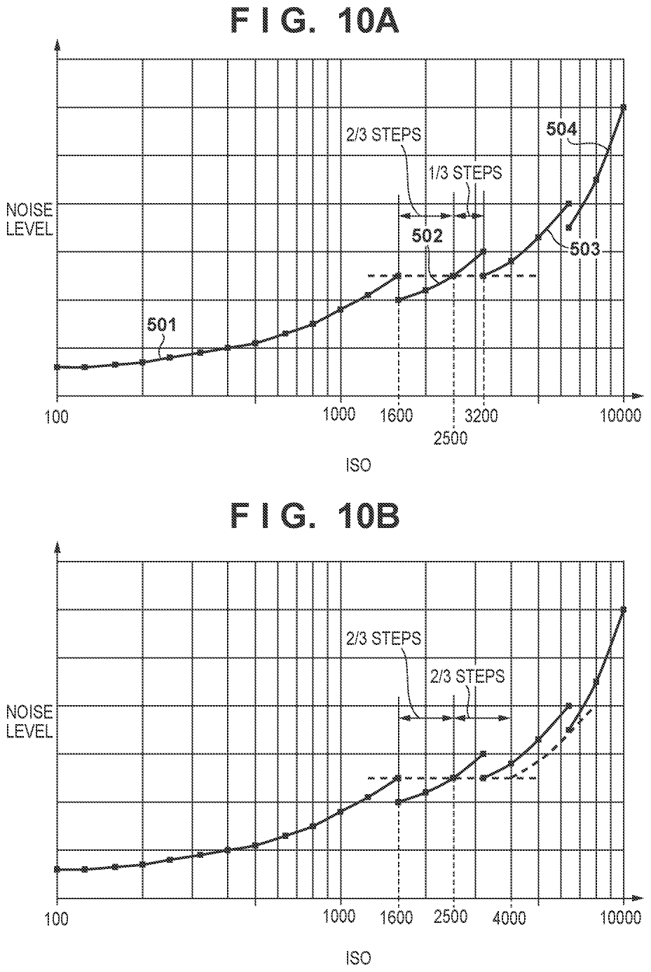

A horizontal broken line in FIG. 10A indicates the state of noise level of the image shown in FIG. 6B. The ISO values at the intersections of the broken line in FIG. 10A and graphs 501, 502, and 503 are ISO 1600, ISO 2500, and ISO 3200 from the low sensitivity side. Here, the interval between ISO 1600 and ISO 2500 is ⅔ steps, but the interval between ISO 2500 and ISO 3200 is ⅓ steps, and the control resolutions are different. Therefore, the exposure is adjusted in the direction in which the exposure can be adjusted by using the exposure adjusting values. For example, if the control resolution set in the digital camera 100 is ⅔ steps, and the exposure can be adjusted by the analog gain circuit built in the image sensor 102, by increasing the exposure by ⅓ steps from ISO 3200, it is possible to adjust the exposure by ⅔ steps between ISO 1600, ISO 2500, and ISO 4000. Also, by reducing the exposure using the ND filter 103, it is possible to adjust the exposure to ISO 1250, ISO 2000, and ISO 3200. These exposure adjustment methods enable changing of ISO value with the control resolution set in the digital camera 100 while keeping the noise level at a similar level.

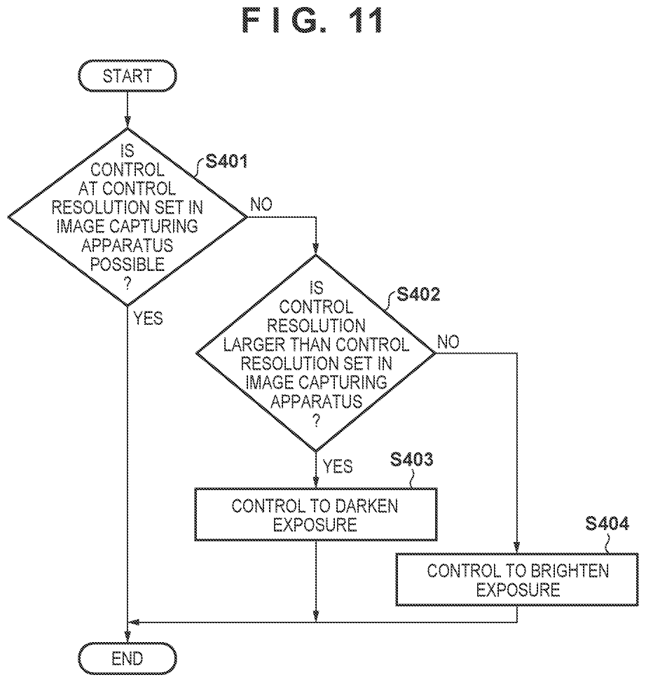

FIG. 11 is a flowchart showing exposure adjustment processing shown in FIGS. 10A and 10B. In step S401, it is determined whether or not the control resolution between the selectable ISO values with similar noise levels is the same as the control resolution set in the digital camera 100. If it is determined that they are the same, exposure adjustment is not performed, and the ISO value is changed with the current control resolution. On the contrary, if it is determined in step S401 that the control resolutions are different, the process proceeds to step S402. In step S402, the magnitude of the control resolution between the selectable ISO values with similar noise levels is compared to the magnitude of the control resolution set in the digital camera 100. If it is determined that the magnitude of the control resolution between the selectable ISO values with similar noise levels is larger than the magnitude of the control resolution set in the digital camera 100, the exposure control is performed so as to darken the exposure using exposure control unit.

For example, it is assumed that the control resolution set in the digital camera 100 is ⅔ steps, and the selectable ISO values at a similar noise level are ISO 1600, ISO 2500, and ISO 5000. In this case, the control resolution between ISO 1600 and ISO 2500 is ⅔ steps, but the control resolution between ISO 2500 and ISO 5000 is 1 step. In that case, the exposure is adjusted from ISO 5000 to ISO 4000 by using an exposure adjustment unit such as the ND filter 103 that can darken the exposure. As a result, the control resolution of the selectable ISO values with a similar noise level becomes the same as the control resolution set in the digital camera 100.

Similarly, in step S402, if it is determined that the magnitude of the control resolution between the selectable ISO values with similar noise levels is smaller than the magnitude of the control resolution set in the digital camera 100, the exposure control is performed so as to brighten the exposure using an exposure control unit. For example, it is assumed that the control resolution set in the digital camera 100 is ⅔ steps, and the selectable ISO values with a similar noise level are ISO 1600, ISO 2500, and ISO 3200. In this case, the control resolution between ISO1600 and ISO2500 is ⅔ steps, but the control resolution between ISO2500 and ISO3200 is ⅓ steps. In that case, the exposure is adjusted from ISO 3200 to ISO 4000 by using an exposure adjustment unit such as an analog gain circuit built in the image sensor 102 that can brighten the exposure. These exposure adjustment methods enable changing of ISO value with the control resolution set in the digital camera 100 while keeping the noise level at a similar level.

As described above, according to the fourth embodiment, it is possible to control ISO values with the control resolution set in the image capturing apparatus even in a mode in which shooting can be performed at similar noise levels.

Here, control with an analog gain circuit and an ND filter, which exert little effect on image creation of captured images, is shown. However, exposure may be adjusted by adjusting the aperture and shutter speed if image creation is not particularly aimed at or if the diaphragm control unit 112 and shutter control unit 110 are set to AUTO control.

### Fifth Embodiment

Next, a fifth embodiment of the present invention will be described.

There are cases where, after the user selects the noise level, characteristics of noise such as the noise level and noise graininess change due to changes in the camera settings other than the noise level. For example, when the settings for 4K output setting are changed to the settings for 2K output, the noise characteristics change if the 2K video is generated by reducing the 4K video. Techniques for reducing moire and noise by performing so-called bandpass filtering to reduce high-frequency components during reduction processing are known. It is also known that the reduction process reduces the size of each piece of noise, which changes the graininess of the noise.

This embodiment describes an example of displaying a warning to the user in a case where noise characteristics change due to changes other than settings that obviously changes the noise level, such as changing the noise level (that is, changing the gain value) and changing the settings of the known noise reduction processing that is a noise reduction function, after the noise level is selected. Especially for a user who has little shooting experience, such a warning display is helpful for shooting at similar noise levels. A warning is displayed on the display unit 107, for example, based on the instruction from the main body control unit 119, but instead of the display, the user may be warned by another method such as voice.

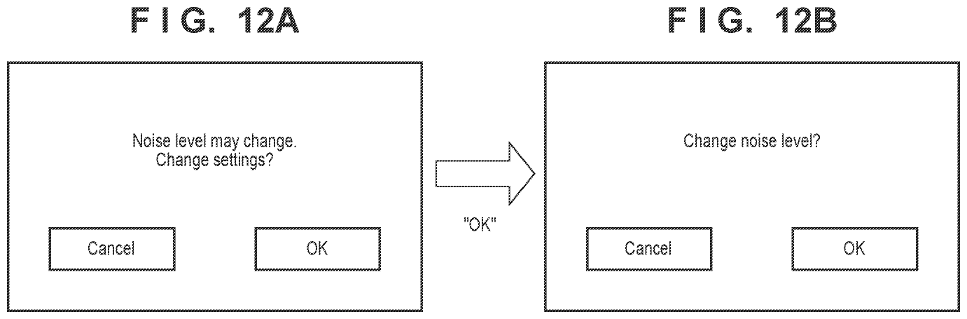

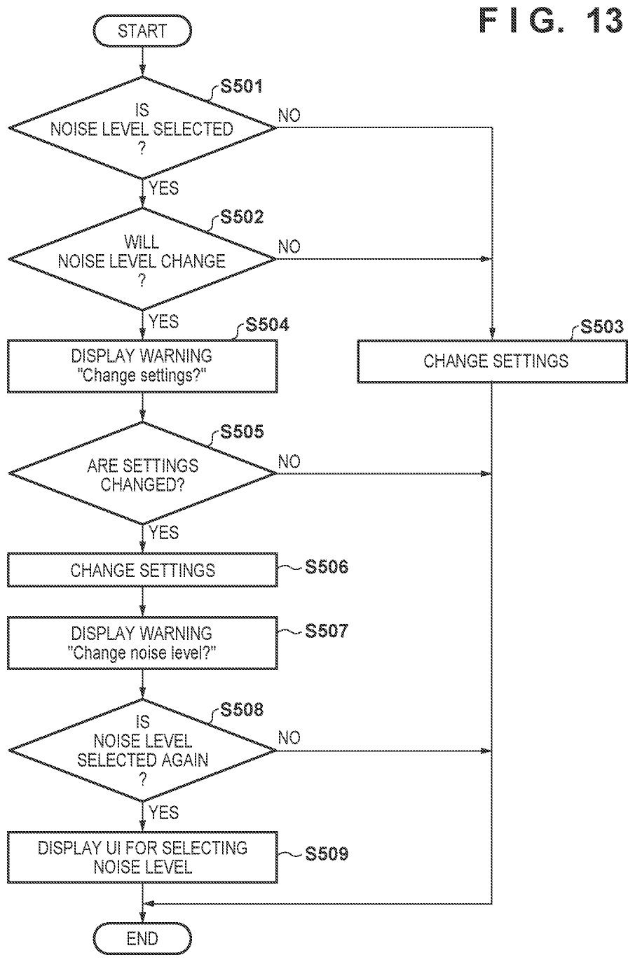

In this embodiment, a case where the output resolution is changed from 4K to 2K as described above after the noise level is selected will be described with reference to FIGS. 12A, 12B and 13 as an example.

FIGS. 12A and 12B are examples of screen display for displaying a warning to the user when the noise level changes due to change in settings. In a case where the user change a setting that causes a change in the noise level, a screen as shown in FIG. 12A is displayed, and if the user selects “OK” on the screen as shown in FIG. 12A, the noise level is changed and, after the camera setting is changed, a screen such as that shown in FIG. 12B for prompting to change the noise level is displayed. When the user selects “OK” on the screen shown in FIG. 12B, the screen transitions, as shown in FIGS. 3A to 3F or FIGS. 6A to 6F, for providing the user of gain values capable of shooting at similar noise levels is performed. If the user selects “Cancel” in the screen shown in FIG. 12A, the user can exit from the selection screen, and this time, the camera settings are not changed. On the other hand, if the user selects “Cancel” in the screen shown in FIG. 12B, the user can exit from the selection screen.

FIG. 13 is a flowchart illustrating the screen transition processing shown in FIGS. 12A and 12B.

In step S501, it is determined whether the noise level is selected by the user. If the noise level is not selected, the process advances to step S503 to change the camera settings as instructed by the user, and the process ends. On the other hand, if the noise level is selected by the user, the process advances to step S502 to determine whether the noise level changes due to the change in camera settings.

To determine the change in noise level, the noise level measured with each camera setting is stored in advance in the ROM or the like in the main body control unit 119, and the main body control unit 119 determines whether the noise level will change due to the setting change. In this embodiment, noise levels of 4K and 2K are stored, and whether or not the noise level changes is determined by comparing the respective noise levels. If the noise level will not change, the process advances to step S503 to change the settings and terminate the process.

If it is determined that the noise level will change, the process advances to step S504 to display a screen asking whether to change the camera settings, as shown in FIG. 12A. Subsequently, the process proceeds to step S505, and if “Cancel” is selected on the screen shown in FIG. 12A, the process ends without changing the camera settings. If “OK” is selected, the process advances to step S506 to change the camera settings. Here, the camera settings are changed from 4K to 2K. After changing the camera settings, the process advances to step S507 to display a screen asking whether to select the noise level again as shown in FIG. 12B. Subsequently, the process proceeds to step S508, and if “Cancel” is selected on the screen shown in FIG. 12B, the process ends without selecting the noise level. On the other hand, if “OK” is selected, the process proceeds to step S509, displays the noise level selection screens shown in FIGS. 3A to 3F or FIGS. 6A to 6F, and after performing the noise level selection process, the processing ends.

As described above, according to the fifth embodiment, in a case where the noise level changes due to change in camera settings where the effect of noise is not clearly known, the user can notice the change in noise, so it becomes possible to make it easy to perform shooting at a similar noise level.

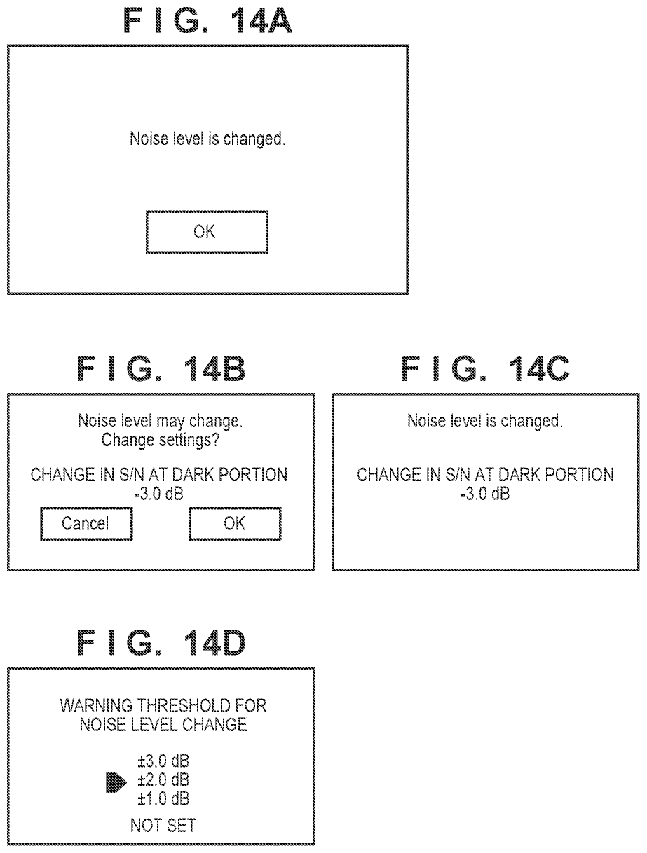

Here, the case where the screen for asking whether to change the camera settings as shown in FIG. 12A and the screen for asking whether to select the noise level as shown in FIG. 12B are displayed has been described as an example. However, in a case where the noise level changes due to change in camera settings, a simple warning may be displayed to indicate that the noise level has changed after the settings are changed. FIG. 14A shows an example of warning display for change in noise level.

In addition, the example of warning about the presence or absence of change in noise level has been explained; alternatively, the S/N ratio of dark random noise in each setting may be measured and recorded in advance, and change in the S/N ratio may be displayed. More specifically, in the processing shown in FIG. 13, instead of the screens shown in FIG. 12A and FIG. 14A, change in S/N ratio in the dark portion may be displayed in dB as shown in FIGS. 14B and 14C.

Further, regarding the warning of change in noise level due to setting change, there may be cases where the warning may not be necessary as when the noise change is small and where the warning itself is not necessary for a user with sufficient shooting experiences. Accordingly, a screen such as that shown in FIG. 14D may be displayed so that the user can specify the threshold for displaying a warning regarding change in S/N ratio. For example, when it is set to ±2.0 dB as shown in FIG. 14D, control is performed so that warning is not displayed when change in the S/N ratio caused by changing the camera settings is 1.0 dB. By making such settings in advance by the user, it is possible to prevent frequent warnings.

In this case, the determination may be made in step S502 of the flowchart shown in FIG. 13 when judging the change in noise level, whether or not the change in S/N ratio at the dark portion caused by the setting change exceeds the threshold set by the user.

Further, as an example of setting the noise level change, the image reduction process for changing the output resolution from 4K to 2K has been described, but it is known that the noise characteristics change even with the change in following process. For example, image enlargement/reduction processing including electronic image stabilization processing; codec recording methods such as H.264, YCC420, and YCC422; and actuation methods of image sensor such as addition/non-addition. In addition, the noise level changes in cases where optical correction processing known as peripheral illumination correction and diffraction correction, color conversion processing related to saturation, hue, and color gamut, edge enhancement processing such as sharpness enhancement, gradation conversion processing represented by gamma, black level correction processing known as auto black balance, pedestal, and so forth, are performed.

Further, it is known that the noise characteristics also change according to the temperature of the image sensor. Accordingly, the image sensor 102 may be provided with a thermistor for acquiring the temperature of the image sensor 102, the noise level may be estimated according to the temperature measured by the thermistor, and the change in noise level may be determined according to the estimated noise level. In this case, the main body control unit 119 may estimate the noise level and determine the change in noise level.

By measuring the noise level in each setting described above in advance and storing the measured data in the ROM in the main body control unit 119, the change in noise level can be determined. It should be noted that the noise level may be determined from images obtained with each setting while the lens is in the light blocking state, and the method of determining the change in noise level is not particularly limited.

Although the present invention has been described in detail based on the preferred embodiments, the present invention is not limited to these specific embodiments, and various forms without departing from the gist of the present invention can be applied to the present invention. Parts of the above-described embodiments may be combined as appropriate.

In each of the above-described embodiments, the case where the present invention is applied to a digital camera has been described as an example, but the present invention is not limited to this. That is, the present invention may be applied to any device equipped with an image sensor. That is, the present invention can be applied to mobile phone terminals, portable image viewers, televisions equipped with cameras, digital photo frames, music players, game machines, electronic book readers, and electronic devices capable of capturing images.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-027010, filed Feb. 24, 2022 which is hereby incorporated by reference herein in its entirety.

What is claimed is:

1. An electronic apparatus comprising:
an image sensor that shoots a subject and outputs image data;
a controller that controls sensitivity of the image sensor;
a display that displays an image based on the image data; and
a selector that selects an acceptable noise level based on noise of the image displayed on the display,
wherein the controller limits the sensitivity based on the selected noise level, and
wherein the controller and the selector are implemented by one or more processors, circuitry or a combination thereof.

2. The electronic apparatus according to claim 1, wherein the controller has a first gain controller that control an analog gain and a second gain controller that controls a digital gain, and
wherein the controller controls the sensitivity using the analog gain and the digital gain in combination.

3. The electronic apparatus according to claim 2, wherein resolution of the digital gain is finer than resolution of the analog gain.

4. The electronic apparatus according to claim 2, wherein a first mode for changing the analog gain and a second mode for not changing the analog gain are provided, and
wherein in a case where the first mode is set, the selector is enabled, and in a case where the second mode is set, the selector is disabled.

5. The electronic apparatus according to claim 1, wherein the image sensor outputs plural kinds of image data with different sensitivities controlled by the controller, and
wherein the display sequentially displays a plurality of images based on the plural kinds of image data.

6. The electronic apparatus according to claim 1, wherein the image sensor outputs plural kinds of image data with different sensitivities controlled by the controller, and
wherein the display displays a plurality of images based on the plural kinds of image data in parallel.

7. The electronic apparatus according to claim 1, wherein the selector selects the acceptable noise level by selecting an image whose noise is acceptable.

8. The electronic apparatus according to claim 1, wherein the controller limits a range of the sensitivity so that noise in an image is less than the selected noise level.

9. The electronic apparatus according to claim 8, wherein the display displays the limited range of the sensitivity.

10. The electronic apparatus according to claim 1, wherein the controller limits the sensitivity to a sensitivity that causes noise of the selected noise level.

11. The electronic apparatus according to claim 10, wherein the display displays the limited sensitivity.

12. The electronic apparatus according to claim 1 further comprising a switching unit that switches between a third mode for selecting the acceptable noise level and a forth mode for not selecting the acceptable noise level,
wherein the controller controls control values including the sensitivity for adjusting exposure so that a predetermined target luminance value is achieved,
wherein, in a case where the third mode is set, the controller does not change the control value of the sensitivity, and
wherein the switching unit is implemented by one or more processors, circuitry or a combination thereof.

13. The electronic apparatus according to claim 12, wherein the control values for adjusting exposure include control values for controlling sensitivity, diaphragm, shutter, and neutral density element.

14. The electronic apparatus according to claim 12, wherein the controller controls at least one of size of a photometry frame and a position of the photometry frame for evaluating brightness of the image data, a threshold for color or luminance information to be evaluated, and a target luminance value to be different between the third mode and the fourth mode.

15. The electronic apparatus according to claim 2, wherein the controller controls control values including the sensitivity for adjusting exposure so that a predetermined target luminance value is achieved, and
wherein, in a case where resolution of the analog gain and control resolution of gain values set in the electronic apparatus are different from each other, the controller adjusts a control value or values except for a control value of the sensitivity among the control values to shift the exposure so that the control resolution and the resolution of the analog gain become the same.

16. The electronic apparatus according to claim 15, wherein the control values include control values for controlling sensitivity, diaphragm, shutter, and neutral density element.

17. The electronic apparatus according to claim 1 further comprising:
a determination unit that determines change in noise level according to settings of the electronic apparatus or characteristics of the image sensor; and
a warning unit that issues a warning in a case where the acceptable noise level is selected by the selector and a change in noise level is determined by the determination unit,
wherein the determination unit and the warning unit are implemented by one or more processors, circuitry or a combination thereof.

18. The electronic apparatus according to claim 17, wherein the determination unit determines the change in noise level based on at least one of enlargement/reduction processing on the image data output from the image sensor, image stabilization processing, recording method of the image data, readout method of the image sensor, actuation method of the image sensor, optical correction processing, color conversion processing regarding saturation and hue, color gamut conversion processing, edge enhancement processing, gradation conversion processing, noise reduction processing, and black level correction processing.

19. The electronic apparatus according to claim 17 further comprising an acquisition unit that acquires temperature of the image sensor,
wherein the determination unit determines the change in noise level based on the acquired temperature, and
wherein the acquisition unit is implemented by one or more processors, circuitry or a combination thereof.

20. The electronic apparatus according to claim 17 further comprising an estimation unit that estimates an amount of change in noise level based on the settings of the electronic apparatus or the characteristics of the image sensor,
wherein the warning unit warns the amount of change in noise level estimated by the estimation unit, and
wherein the estimation unit is implemented by one or more processors, circuitry or a combination thereof.

21. The electronic apparatus according to claim 20 further comprising a setting unit that sets an acceptable amount of change in noise level,
wherein the warning unit issues the warning in a case where the amount of change in noise level estimated by the estimation unit exceeds the acceptable amount of change in noise level, and
wherein the setting unit is implemented by one or more processors, circuitry or a combination thereof.

22. A control method of an electronic apparatus comprising:
shooting a subject by an image sensor and outputting image data;
displaying an image based on the image data on a display;
selecting an acceptable noise level based on noise of the image displayed on the display; and
limiting sensitivity of the image sensor based on the selected noise level.

23. A non-transitory computer-readable storage medium, the storage medium storing a program that is executable by the computer, wherein the program includes program code for causing the computer to execute a control method of an electronic apparatus, comprising:
shooting a subject by an image sensor and outputting image data;
displaying an image based on the image data on a display;
selecting an acceptable noise level based on noise of the image displayed on the display; and
limiting sensitivity of the image sensor based on the selected noise level.
